(19) United States
(12) Patent Application Publication
(10) Pub. No.: US 2012/0106185 A1
(43) Pub. Date: May 3, 2012

(54) LIGHT EMITTING DEVICE, ILLUMINATING EQUIPTMENT, AND VEHICLE HEADLAMP

(75) Inventors: Katsuhiko KISHIMOTO, Osaka-shi (JP); Yoshitaka Tomomura, Osaka-shi (JP); Hidenori Kawanishi, Osaka-shi (JP)

(73) Assignee: SHARP KABUSHIKI KAISHA, Osaka-shi (JP)

(21) Appl. No.: 13/281,197

(22) Filed: Oct. 25, 2011

(30) Foreign Application Priority Data
Oct. 29, 2010 (JP) 2010-244565

(51) Int. Cl. B60Q 1/04; F21V 9/00

(52) U.S. Cl. 362/510; 362/293

(57) ABSTRACT

A headlamp of the present invention includes: a laser diode for emitting a laser beam with coherence; and a light emitting section which, upon irradiation with the laser beam from the laser diode, emits light so that the light is outputted from the light emitting device. The headlamp further includes an excitation light output prevention member for preventing the laser beam from the laser diode from being outputted from the headlamp while the laser beam maintains coherence.

This Nonprovisional application claims priority under 35 U.S.C. §119(a) on Patent Application No. 2010-244565 filed in Japan on Oct. 29, 2010, the entire contents of which are hereby incorporated by reference.

### TECHNICAL FIELD

The present invention relates to a light emitting device serving as a high-intensity light source, to an illuminating equipment including the light emitting device, and to a vehicle headlamp.

### BACKGROUND ART

In recent years, studies have been intensively carried out for a light emitting device that uses, as illumination light, fluorescence generated by a light emitting section which includes a fluorescent material. The light emitting section generates the fluorescence upon irradiation with excitation light, which is emitted from an excitation light source. The excitation light source used is a semiconductor light emitting element, such as a light emitting diode (LED), a laser diode (LD), or the like.

An example of a technique relating to such a light emitting device is a lamp disclosed in Patent Literature 1. In order to achieve a high-luminance light source, the lamp employs a laser diode as an excitation light source. Since a laser beam emitted from the laser diode is coherent and therefore highly directional, the laser beam can be collected without a loss so as to be used as excitation light. The light emitting device employing such a laser diode as the excitation light source is suitably applicable to a vehicle headlamp.

In particular, the lamp of Patent Literature 1 is designed such that the semiconductor light emitting element emits ultraviolet light and the fluorescent material emits white light in response to the ultraviolet light. The fluorescent material can emit white light with high luminance. The fluorescent material produces white diffusing light in response to the ultraviolet light.

The lamp includes a transparent member positioned before the fluorescent material. The transparent member is made of a material which transmits white light and blocks ultraviolet light.

The transparent member transmits light from the fluorescent material toward the front of a vehicle, whereas blocks ultraviolet light which is emitted from the semiconductor light emitting element and harmful to a human body from being outputted outside the vehicle.

Alternatively, the transparent member itself may be made of a material that transmits ultraviolet light and is provided, on a front surface of the transparent member, with a member which blocks ultraviolet light.

### Citation List

### Patent Literatures

### Patent Literature 1

Japanese Patent Application Publication No. 2005-150041 (published on Jun. 9, 2005)

### SUMMARY OF INVENTION

### Technical Problem

As described above, in the lamp of Patent Literature 1, ultraviolet light from the semiconductor light emitting element is blocked so as not to be outputted outside the vehicle. Since ultraviolet light is invisible, illumination light is not required to include ultraviolet light, and so all the ultraviolet light may be blocked simply.

Further, it is generally known that ultraviolet light has adverse effects on eyes and skins. An example of the adverse effects of ultraviolet light on eyes is keratitis (e.g. inflammation of a cornea on the uppermost surface of an eyeball). Examples of the adverse effects of ultraviolet light on skins include sunburn and deterioration of DNA possibly inducing skin cancers.

Accordingly, the lamp is required to block ultraviolet light.

A laser beam from a semiconductor light emitting element is coherent light. Coherent light can be roughly classified into two kinds: invisible coherent light (light with a wavelength in an ultraviolet range or infrared range); and visible coherent light (light with a wavelength in a visible range).

Coherent light can be easily converged onto an extremely small spot by an optical system such as a lens, and can locally have extremely high energy. Accordingly, when coherent light enters eyes for example, there is a possibility that a pinpoint on a retina is irradiated with converged light and concentration of light energy on the pinpoint hurts optical nerves.

In consideration of such characteristics of coherent light, it is necessary to block coherent light with a wavelength in a visible range as well as coherent light with a wavelength in an ultraviolet range or infrared range including ultraviolet light.

In general, coherent light is defined as light with spatially and temporally uniform phase, and has a single-wavelength. Accordingly, a member for blocking coherent light should be a member which blocks only wavelength and its adjacent ones of the coherent light.

In a case of blocking coherent light in a visible range, blocking a wavelength range broader than necessary would also block much of light necessary as illumination light other than the coherent light. Accordingly, it is important to make a wavelength range to be blocked as narrow as possible so that only a wavelength range in which the coherent light is presented is blocked.

However, Patent Literature 1 neither describes nor suggests blocking the coherent light in a visible range.

The present invention was made in view of the foregoing problem. An object of the present invention is to provide a light emitting device capable of preventing coherent light from being outputted outside, and an illuminating equipment and a vehicle headlamp each including the light emitting device.

### Solution to Problem

In order to solve the foregoing problem, a light emitting device of the present invention includes: an excitation light source for emitting excitation light with coherence; and a light emitting section which, upon irradiation with the excitation light from the excitation light source, emits light so that the light is outputted from the light emitting device, the light emitting device further including an excitation light output prevention member for preventing the excitation light from the excitation light source from being outputted from the light emitting device while the excitation light maintains coherence.

With the light emitting device, the light emitting section emits light upon irradiation with the excitation light. When the light emitting section emits light, coherence of the excitation light with which the light emitting section is irradiated is normally reduced sufficiently by absorption and/or scattering by the fluorescent material contained in the light emitting section.

However, some of the excitation light from the excitation light source may be not used in emission by the light emitting section and travel toward the output side of the light emitting device while maintaining coherence in a level which has an adverse influence on human bodies.

Examples of such excitation light which comes from the excitation light source and travels toward the output side of the light emitting device while maintaining coherence include: (a) excitation light with which the light emitting section is not irradiated; (b) excitation light with which the light emitting section is irradiated but which is neither absorbed nor scattered by the fluorescent material contained in the light emitting section so that the excitation light is outputted from the light emitting section without any change; (c) excitation light with which the light emitting section is irradiated but which is reflected by the surface of the light emitting section so that the excitation light is outputted while substantially maintaining coherence.

In a case where the excitation light with coherence in a level which has an adverse influence on human bodies is outputted from the light emitting device without any change, when the excitation light enters human eyes, there is a possibility that a pinpoint on a retina is irradiated with converged light and concentration of light energy on the pinpoint hurts optic nerves.

In order to deal with this problem, the light emitting device of the present invention includes the excitation light output prevention member which prevents the excitation light with coherence from being outputted from the light emitting device without any change.

### Advantageous Effects of Invention

As described above, a light emitting device of the present invention includes: an excitation light source for emitting excitation light with coherence; and a light emitting section which, upon irradiation with the excitation light from the excitation light source, emits light so that the light is outputted from the light emitting device, the light emitting device further including an excitation light output prevention member for preventing the excitation light from the excitation light source from being outputted from the light emitting device while the excitation light maintains coherence.

Therefore, the light emitting device of the present invention yields an effect of preventing the coherent light from being outputted outside.

### BRIEF DESCRIPTION OF DRAWINGS

FIG. 1 is a view schematically showing a configuration of a headlamp according to one embodiment of the present invention.

FIG. 2 is a view showing an effect of an excitation-light output prevention film included in the headlamp (version 1).

FIG. 3 is a view showing an effect of the excitation-light output prevention film included in the headlamp (version 2).

FIG. 4 is a cross sectional view schematically showing a configuration of the excitation-light output prevention film included in the headlamp.

FIG. 5 is a view schematically showing a configuration of a headlamp according to another embodiment of the present invention.

FIG. 6(a) is a circuit view showing a laser diode.

FIG. 6(b) is a perspective view showing a basic structure of the laser diode.

FIG. 7 is a view schematically showing (i) an exterior of a light-emitting unit included in a laser downlight according to the embodiment of the present invention and (ii) an exterior of a conventional LED downlight.

FIG. 8 is a cross sectional view showing a ceiling to which the laser downlight is installed.

FIG. 9 is a cross sectional view showing the laser downlight.

FIG. 10 is a cross sectional view showing a modified example of a method for installing the laser downlight.

FIG. 11 is a cross sectional view showing a ceiling to which the LED downlight is installed.

FIG. 12 is a table in which specifications of the laser downlight and those of the LED downlight are compared with each other.

### DESCRIPTION OF EMBODIMENTS

### Embodiment 1

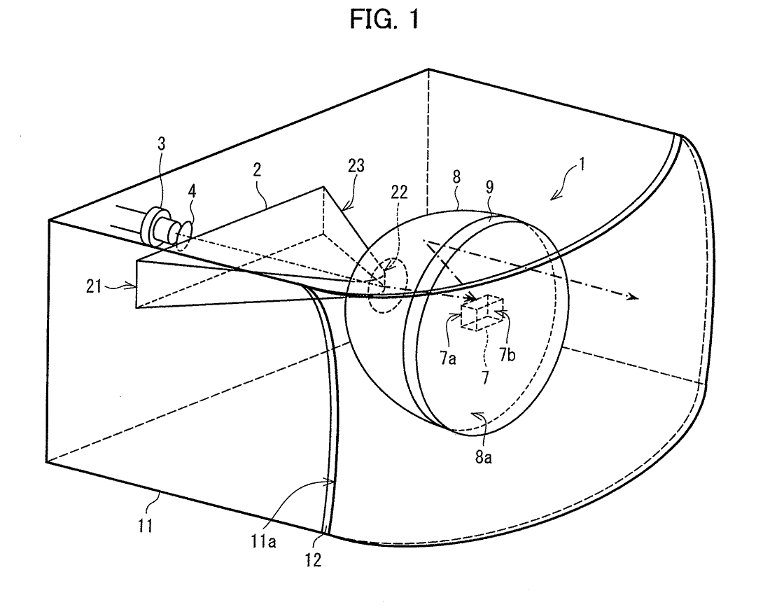

One embodiment of the present invention is described below with reference to FIGS. 1 through 4. In the present embodiment, a headlamp 1 satisfying light distribution property standards for a driving headlamp (high beam) for use in an automobile is described as an example of an illuminating equipment according to the present invention. Note, however, that the illuminating equipment of the present invention can be achieved also as a headlamp which meets the light distribution property standards of a passing headlamp (low beam) for an automobile or a headlamp for a vehicle other than the automobile or for a moving object other than the automobile (e.g., a person, a vessel, an airplane, a submersible vessel, or a rocket) or can be achieved as other illuminating equipment. Examples of the other illuminating equipment include a searchlight, a projector, and lighting equipment for housing.

(Configuration of Headlamp 1)

With reference to FIG. 1, the following describes a configuration of the headlamp 1 (illuminating equipment) 1 according to the present embodiment. FIG. 1 is a view schematically showing the configuration of the headlamp 1 according to the present embodiment. As shown in FIG. 1, the headlamp 1 includes a laser diode (excitation light source) 3, an aspheric lens 4, a light guide section 2, a light emitting section 7, a reflection mirror 8, a transparent plate 9, a housing 11, and an excitation-light output prevention film (excitation-light output prevention member, absorbent member, scattering member) 12.

(Laser Diode 3)

The laser diode 3 functions as an excitation light source for emitting excitation light. The laser diode 3 emits a laser beam (excitation light). The laser diode 3 can be provided in plural numbers. In such an event, each of a plurality of laser diodes 3 emits a laser beam.

The excitation light emitted from the laser diode 3 is coherent light having coherence. As described early, the coherent light is generally light being spatially and temporally in phase. A wavelength of the coherent light is a single wavelength.

The laser diode 3 has ten light emitting points (ten stripes) per chip. For example, the laser diode 3 emits a laser beam of 405 nm (blue violet), has an output of 11.2 W, an operating voltage of 5 V and an operating current of 6.4 A, and is mounted on a stem having a diameter of 15 mm. In a case where the laser diode 3 is caused to emit a laser beam at the output of 11.2 W, an electric power consumption of the laser diode is 32 W (5 V×6.4 A). Obviously, the laser beam emitted from the laser diode 3 is not limited to 405 nm, and may be any laser beam as long as the laser beam has a peak wavelength in a wavelength range of 400 nm or greater but not greater than 420 nm.

In a case where three laser diodes 3 are mounted, for example, an optical output (emission bundle) of the laser diodes 3 as a whole is 33.6 W and an electric power consumption thereof is 96 W (=5 V×6.4 A×3). In order to obtain a laser beam of a high output, it is preferable to use a plurality of laser diodes 3.

The aspheric lens 4 is a lens for receiving the laser beam emitted from the laser diode 3 and entering it in a light entrance surface 21, i.e., a first end part, of the light guide section 2. For example, FLKN1 405 manufactured by ALPS ELECTRIC CO., LTD. can be used as the aspheric lens 4. The aspheric lens 4 is not particularly limited in shape and material, provided that it has the foregoing function. However, it is preferable that a material of the aspheric lens 4 has (i) a high transmittance with respect to light at and around a wavelength of 405 nm which is the wavelength of the excitation light and (ii) a good heat resistance.

(Light Guide Section 2)

The light guide section 2 is for converging the laser beam emitted from the laser diode 3 and guiding it to a laser-beam irradiation surface 7a of the light emitting section 7. The light guide section 2 is a light guide member of a trapezoid shape having a rectangular bottom surface and being tapered. The light guide section 2 is optically combined with the laser diode 3 via the aspheric lens 4. The light guide section 2 has (i) the light entrance surface 21 for receiving the laser beam emitted from the laser diode 3 and (ii) a light output surface 22 for outputting, toward the light emitting section 7, the laser beam received on the light entrance surface 21. That is, the light guide section 2 has the light entrance surface 21 provided at a bottom part and the light output surface 22 provided at a top part.

The light output surface 22 has an area smaller than that of the light entrance surface 21. Accordingly, the laser beam which has entered the light entrance surface 21 is converged by traveling forward while being reflected on side surfaces 23 of the light guide section 4. The laser beam thus converged is emitted from the light output surface 22.

The area of the light entrance surface 21 is 15 mm×3 mm and the area of the light output surface 22 is 3 mm×1 mm, for example. A height of the light guide section 2, in other words, a distance between the light entrance surface 21 and the light output surface 22, is 50 mm, for example. The side surfaces 23 of the light guide 2 are coated with a fluororesin (polytetrafluoroethylene) having a refraction index of 1.35. The side surfaces 23 thus coated with the fluororesin can efficiently reflect a laser beam. This is because the fluororesin and a transparent material forming the light guide section 2 have different refraction indices.

The light output surface 22 may be a planoconvex cylindrical lens whose axis runs in a direction vertical to an axis passing through the light entrance surface 21 and the light output surface 22. That is, the light output surface 22 may have a curved surface shape. In such an event, the laser beam is emitted from the light output surface 22 so as to spread at a given angle. In this way, the laser beam emitted from the light output surface 22 is dispersed. Accordingly, the laser beam irradiation surface 7a is irradiated with the laser beam thus dispersed, instead that one spot of the laser beam irradiation surface 7a is concentratedly irradiated with the laser beam. This makes it possible to prevent the light emitting section 7 from being deteriorated by concentric irradiation of the one spot of the laser beam irradiation surface 7a with the laser beam. Therefore, it is possible to realize the headlamp 1 which has a high light flux, a high brightness, and an extended operating life.

In the present embodiment, the light output surface 22 functions as a cylindrical lens. Alternatively, the light output surface 22 may be provided with an independent cylindrical lens. In such an event, the independent cylindrical lens is provided between the light output surface 22 and the light emitting section 7.

Specifically, the light guide section 2 is made from silica glass (SiO₂, refractive index of 1.45), an acrylic resin, or other transparent materials. The light entrance surface 21 may have a planar shape or a curved surface shape.

A coupling efficiency of the aspheric lens 4 and the light guide section 2 (a ratio of an intensity of the laser beam emitted from the light output surface 22 of the light guide section 2 with respect to an intensity of the laser beam emitted from the laser diode 3) is 90%. Consequently, a power of a laser beam of about 11.2 W emitted from the laser diode 3 will be about 10 W when the laser beam is emitted from the light output surface 22 after passing through the aspheric lens 4 and the light guide section 2.

(Light Emitting Section 7)

The light emitting section 7 emits light upon irradiation with the laser beam emitted from the laser output surface 22. The light emitting section 7 includes fluorescent materials that emit light upon irradiation with the laser beam. The light emitting section 7 is provided on an inward side (a side on which the 22 is provided) of the transparent plate 9 so as to be fixed to or near a focal position of the reflection mirror 9. A method for fixing the light emitting section 7 is not limited to this, and the light emitting section 7 may be fixed by a rod-like or tubular member extended from the reflection mirror 8.

As described above, the light emitting section 7 emits light upon the irradiation with the laser beam. The laser beam is coherent light emitted from the laser diode 3. The light emitting section 7 is irradiated with the coherent light and emits incoherent light (white light) not having coherence.

The light emitting section 7 is described in detail later.

(Reflection Mirror 8)

The reflection mirror 8 has an opening. The reflection mirror 8 reflects the incoherent light emitted from the light emitting section 7, thereby forming a bundle of beams traveling within a predetermined solid angle to be emitted via the opening. That is, the reflection mirror 8 reflects light emitted from the light emitting section 7, thereby forming a bundle of beams traveling in a forward direction from the headlamp 1. That is, the reflection mirror 8 outputs the bundle of beams toward an output side of the headlamp 1. For example, the reflection mirror 8 is a member having a curved surface (cup shape, mortar shape) coated with a metal thin film. The opening of the reflection mirror 8 opens toward a direction in which the reflected light travels.

The reflection mirror 8 is not limited to a hemispherical mirror, but may be an ellipsoidal mirror, a parabola mirror, or a mirror having a partial curved surface of the hemispherical mirror, the ellipsoidal mirror, and/or the parabola mirror. That is, the reflection mirror 8 may be any, provided that its reflection surface has at least a part of a curved surface formed by rotating a figure (ellipsoid, circle, or parabola) on a rotation axis. Also, the opening of the reflection mirror 8 is not limited to a circular shape. The shape of the opening of the reflection mirror 8 can be determined as appropriate, depending on designs of the headlamp 1 and a member surrounding it.

An area of the reflection mirror 8 with respect to a front direction is called an opening area of the reflection mirror 8. The opening area is the area of an image of the reflection mirror 8 projected on a plane perpendicular to the optical axis of the reflection mirror 8. In still other words, the opening area is the area of a region surrounded by the opening of the reflection mirror 8 (region shown by a reference sign 8a in FIG. 1). Smallness in the opening area indicates smallness in the reflection mirror 8, resulting in smallness in the headlamp 1. In order for the headlamp 1 to be small, it is preferable that the opening area of the reflection mirror 8 be not greater than 2000 mm².

The transparent plate 9 is a transparent resin plate covering the opening of the reflection mirror 8. The transparent plate 9 is for holding the light emitting section 7. The transparent plate 9 is made from a material that transmits therethrough any of coherent light and incoherent light as described earlier. Accordingly, the transparent plate 9 may be made from any transparent material. This can make it easier and less costly to produce the transparent plate 9.

Obviously, the transparent plate 9 can be omitted in a case where, as described earlier, the light emitting section 7 is held by a member other than the transparent plate 9, such as the rod-like or tubular member extended from the reflection mirror 8.

(Composition of Light Emitting Section 7)

The light emitting section 7 is a member in which a fluorescent material is dispersed inside a silicone resin that serves as a fluorescent material retention substance. A ratio of the silicone resin to the fluorescent material is around 10:1. The light emitting section 7 may be formed by pressing the fluorescent material into a solid. The fluorescent material retention substance is not limited to the silicone resin and may be organic-inorganic hybrid glass or inorganic glass.

The fluorescent material is, for example, any of an oxynitride-based fluorescent material and a nitride-based fluorescent material, or a combination thereof. The fluorescent materials of blue, green, and red are dispersed in the silicone resin. Because the laser diode 3 emits a laser beam of 405 nm (blue violet), the light emitting section 7 emits, upon irradiation with the laser beam, white light. On this account, it can be said that the light emitting section 7 is a wavelength conversion material.

The laser diode 3 may emit a laser beam of 450 nm (blue) (or a laser beam close to so-called “blue” having a peak wavelength in a wavelength range of 440 nm or greater but not greater than 490 nm). In this case, the fluorescent material is a yellow fluorescent material or a mixture of green and red fluorescent materials. The yellow fluorescent material is a fluorescent material which emits light having a peak wavelength in a wavelength range of 560 nm or greater but not greater than 590 nm. The green fluorescent material is a fluorescent material which emits light having a peak wavelength in a wavelength range of 510 nm or greater but not greater than 560 nm. The red fluorescent material is a fluorescent material which emits light having a peak wavelength in a wavelength range of 600 nm or greater but not greater than 680 nm.

The fluorescent material is preferably what is commonly called a sialon fluorescent material (which is one type of nitride fluorescent materials). The sialon fluorescent material is a substance in which a part of silicon atoms of silicon nitride is substituted by aluminum atoms, and a part of nitrogen atoms of the silicon nitride is substituted by oxygen atoms. The sialon fluorescent material may be prepared by a solid solution in which alumina (Al₂O₃), silica (SiO₂), rare earth elements, and the like are combined into silicon nitride (Si₃N₄).

Another preferable example of the fluorescent material is a semiconductor nanoparticle fluorescent material using nanometer-sized particles of a III-V compound semiconductor.

One characteristic of the semiconductor nanoparticle fluorescent material is that, even if the nanoparticles are made from an identical compound semiconductor (e.g., indium fluorescent materials: InP), it is possible to cause the nanoparticles to emit light of different colors by changing particle size of the nanoparticles. The change in color occurs due to a quantum size effect. For example, in a case where the semiconductor nanoparticle fluorescent material is made from InP, the semiconductor nanoparticle fluorescent material with a particle size of about 3 nm to 4 nm emit red light. The particle size is evaluated by use of a transmission electron microscope (TEM).

Further, the semiconductor nanoparticle fluorescent material is semiconductor-based, and therefore the life of the fluorescence is short. Accordingly, the semiconductor nanoparticle fluorescent material can quickly convert power of the excitation light into fluorescence, and therefore is highly resistant to high-power excitation light. This is because the emission life of the semiconductor nanoparticle fluorescent material is approximately 10 nanoseconds, which is less by five digits than emission life of a commonly used fluorescent material containing rare earth as a luminescence center.

In addition, since the emission life is short as described above, it is possible to quickly repeat absorption of a laser beam and emission of fluorescence. As such, it is possible to maintain high conversion efficiency with respect to intense laser beams, thereby reducing heat emission from the fluorescent materials.

This makes it possible to further prevent a heat deterioration (discoloration and/or deformation) in the light emitting section 7. As such, it is possible to extend the life of the headlamp 1.

(Shape and Size of Light Emitting Section 7)

The light emitting section 7 has a rectangular parallelepiped shape of dimensions of 3 mm×1 mm×1 mm, for example. In this case, an area of the laser beam irradiation surface 7a which receives the laser beam emitted from the laser diode 3 is 3 mm², and an area of the light emitting surface 7b from which the white light converted from the laser beam is emitted is 3 mm². A light distribution pattern (light distribution) of a vehicle headlamp lawfully stipulated domestically in Japan is narrow in a vertical direction and broad in a horizontal direction. Hence, if the light emitting section 7 is configured to have a shape wide in the horizontal direction (i.e., a cross section of the light emitting section 7 is a substantially rectangular shape), it is easier to achieve the distribution pattern.

The light emitting section 7 may have a shape other than the rectangular parallelepiped shape. The light emitting section 7 may have a cylindrical shape in which the laser beam irradiation surface 7a and the light emitting surface 7b have circular or ellipsoid shapes. The light emitting surface 7b does not necessarily have a planar surface and may have a curved surface. In a case where the laser beam irradiation surface 7a is curved, at least angles of incidence on the laser beam irradiation surface 7a are greatly varied. Consequently, the direction in which the reflected light travels is greatly varied depending on where the laser beam enters the laser irradiation surface 7a. For this reason, there is a case that it is difficult to control a direction in which the laser beam is reflected. On the other hand, in a case where the laser beam irradiation surface 7a is planar, it is easier to control the direction in which the laser beam is reflected. This is because, with the laser beam irradiation surface 7a being planar, directions in which reflected light travels are hardly varied irrespectively of slight variations in where the laser beam enters the laser beam irradiation surface 7a. Consequently, it is easier to take measures such as to provide, depending on circumstances, a laser beam absorber at a location where the reflected light is incident, or the like.

Further, a thickness of the light emitting section 7, i.e., a width extended between the laser beam irradiation surface 7a and the light emitting surface 7b, may be other than 1 mm. The thickness of the light emitting section 7 should be such a thickness that the laser beam received by the laser beam irradiation surface 7a is completely converted to white light by the light emitting section 7 or sufficiently scattered by the light emitting section 7. The light emitting section 7 should have such a thickness that coherent light which is harmful to human bodies is converted to incoherent light harmless to humans or to coherent light in a level which does not have an adverse influence on human bodies.

A required thickness of the light emitting section 7 is changed depending on the ratio of the fluorescent material retention substance to the fluorescent material in the light emitting section 7. The greater a content of the fluorescent material in the light emitting section 7 is, the greater an efficiency of conversion of the laser beam into the white light is. Thus, the light emitting section 7 can be reduced in thickness.

(Housing 11)

The housing 11 houses therein the laser diode 3, the aspheric lens 4, the light guide section 2, the light emitting section 7, the reflection mirror 8, and the transparent plate 9. The housing 11 is sealed. An inside of the housing 11 is filled with a dry air, for example. the dry air has a dew-point temperature of −35° C. for example and thus prevents increases in temperatures of the laser diode 3 and the light emitting section 7.

Two electrode lead wires which are provided to the laser diode 3 are outwardly extended from the housing 11 so as to be connected with a laser drive circuit (which is not shown in figures). The laser drive circuit supplies a driving current to the laser diode 3 by continuously or intermittently applying a predetermined voltage difference across the two electrode lead wires.

The housing 11 has a front surface section (output surface) 11a. Similarly to the transparent plate 9 described earlier, the front end section 11a is made from a material that transmits therethrough both coherent light and incoherent light. The front end section 11a faces the surface 8a surrounded by the opening of the reflection mirror 8. The front end section 11a transmits therethrough the bundle of beams having been formed by the reflection mirror 8 and emitted from the surface 8a. In consideration of transmission of the bundle of beams, the front end section 11a may be configured such that only a part of the front end section 11a, through which part the bundle of beams emitted from the surfaces 8a of the reflection mirror 8 is transmitted, is made from the transmitting material described above.

The front end section 11a of the housing 11 can be made from any transparent material. This can make it easier and less costly to produce the front end section 11a.

Other surfaces (lightproof surfaces) of the housing 11 than the front surface section 11 should be formed by a lightproof member that blocks both coherent light and incoherent light.

(Excitation-Light Output Prevention Film 12)

The excitation-light output prevention film 12 is attached to the front end section 11a of the housing 11. In this case, it can be said that the excitation-light output prevention film 12 is provided on the output side of the headlamp 1 when seen from the light emitting section 7, as shown in FIG. 1.

As described above, the headlamp 1 outputs the bundle of beams formed by the reflection mirror 8 and passed through (i) the transparent plate 9 covering the opening of the reflection mirror 8 and (ii) the front end section 11a of the housing 11.

The bundle of beams formed by the reflection mirror 8 is composed of the light emitted from the light emitting section 7 and having no coherence, i.e., incoherent light. Thus, usually, no coherent light is leaked outside the headlamp 1 even in a case where both the transparent plate 9 and the front end section 11a of the housing 11 are made from the transparent material which transmits therethrough both the coherent light and the incoherent light. This is because, the laser beam emitted from the laser diode 3, i.e., the coherent light, should be directed to the light emitting section 7 and thereby converted to the incoherent light by the light emitting section 7.

However, in reality, there may be a case that the bundle of beams formed by the reflection mirror 8 contains the coherent light. The excitation-light output prevention film 12, in preparation for such an event, takes a role in prevention of leakage of the coherent light outwardly from the headlamp 1. That is, in the case where the bundle of beams formed by the reflection mirror 8 contains the coherent light, the excitation-light output prevention film 12 weakens and blocks the coherent light received thereon, so as to prevent the coherent light from being leaked outwardly from the headlamp 1.

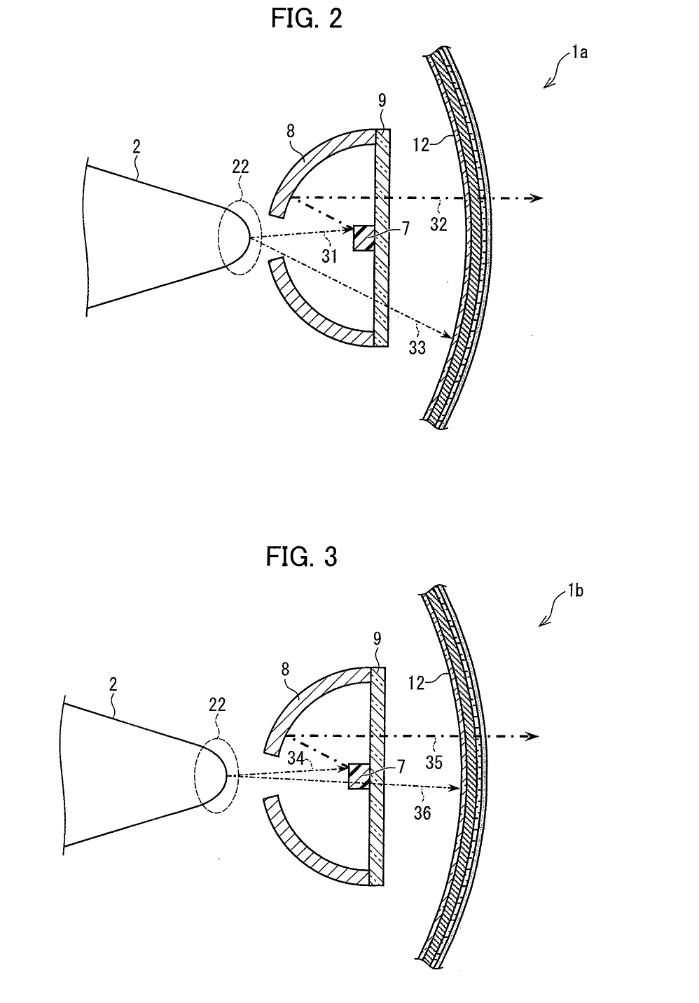

For example, in the headlamp 1a as shown in FIG. 2, the laser beam emitted from the light output surface 22 of the light guide section 2 is usually directed to the light emitting section 7, like a laser beam indicated by a reference sign 31. Then, the laser beam 31 is absorbed by the fluorescent material contained in the light emitting section 7, and thereby converted in wavelength. While this occurs, coherence of the laser beam 31 is lost.

In this case, the bundle of beams formed by the reflection mirror 8 is composed of fluorescent light 32 thus having no coherence. As a result, the bundle of beams must contain no coherent light.

On the other hand, a laser beam indicated by a reference sign 33, out of the laser beam emitted from the light output surface 22 of the light guide section 2, enters no light emitting section 7 while traveling in a direction in which it is emitted from the light output surface 22. This is highly likely the case, depending on a shape of the light output surface 22 of the light guide section 2, a shape of a light entrance opening of the reflection mirror 8 via which light entrance opening the laser beam emitted from the light output surface 22 passes, a location, a size, a shape, and the like of the light emitting section 7.

In such an event, the laser beam 33 that maintains the coherence enters no light emitting section 7 and is transmitted through the transparent plate 9 and the front end section 11a of the housing 11. This is because both the transparent plate 9 and the front end section 11a are made from the transparent material that transmits therethrough even the coherent light.

For another example, in a headlamp 1b as shown in FIG. 3, a laser beam emitted from a light output surface 22 of a light guide section 2 is directed to a light emitting section 7 and usually absorbed by a fluorescent material contained in the light emitting section 7, like a laser beam indicated by a reference sign 34. A wavelength of the laser beam 34 thus absorbed is converted. Coherence of the laser beam 34 is lost at the same time when the wavelength of the laser beam 34 is converted

In this case, a bundle of beams formed by a reflection mirror 8 is composed of fluorescent light 35 thus having no coherence. As a result, the bundle of beams must contain no coherent light.

On the other hand, although a laser beam indicated by a reference sign 36, out of the laser beam emitted from the light output surface 22 of the light guide section 2, is directed to the light emitting section 7, the laser beam indicated by the reference sign 36 is not absorbed by the fluorescent material contained in the light emitting section 7 and thereby emitted from the light emitting section 7.

Here, even if the laser beam emitted from the light output surface 22 is not absorbed by any of the fluorescent materials contained in the light emitting section 7, it is usually scattered by some of the fluorescent materials.

However, there may be a case that some portion of the laser beam directed to the light emitting section 7 is neither absorbed nor scattered by the fluorescent material contained in the light emitting section 7, depending on a path on which the laser beam is transmitted through an inside of the light emitting section 7 and/or depending on a dispersion distribution of the fluorescent material contained inside the light emitting section 7.

In such an event, although the laser beam 36 is directed to the light emitting section 7, the laser beam 36 is neither absorbed nor scattered by the fluorescent materials contained in the light emitting section 7 and is thereby emitted from the light emitting section 7. That is, the laser beam 36 that maintains coherence is emitted from the light emitting section 7.

Thereafter, the laser beam 36 maintaining the coherence is transmitted through the transparent plate 9 and the front end section 11a of the housing 11.

In this way, there is a case that the bundle of beams formed by the reflection mirror 8 contains coherent light.

As described earlier, the excitation-light output prevention film 12 is attached to the front end section 11a of the housing 11. The excitation-light output prevention film 12 has an excitation-light output prevention function (which is later described) that dissolves the coherence of a bundle of beams passing through the excitation-light output prevention film 12.

As a result of the excitation-light output prevention function, the excitation-light output prevention film 12 attenuates and blocks the coherent light contained in the bundle of beams transmitted through the transparent plate 9 and the front end section 11a of the housing 11 as above. Thus, even if the bundle of beams formed by the reflection mirror 8 contains the coherent light, it is possible to prevent the coherent light from being leaked outside the headlamp 1 while the coherent light is maintained in a level which has an adverse influence on human bodies.

Concrete examples of the excitation-light output prevention film 12 are described below.

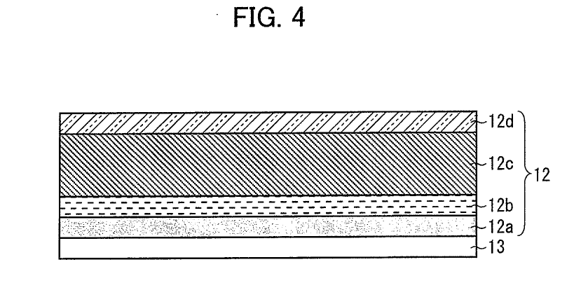

For example, the excitation-light output prevention film 12 can be an optical film that attenuates and blocks a light component having a wavelength of at least 400 nm or greater but not greater 420 nm. An example of the optical film can be UV Guard manufactured by NAIGAI TECHNOS Co., jp Ltd. FIG. 4 schematically shows a configuration of the excitation-light output prevention film 12 that is the optical film.

As shown in FIG. 4, the excitation-light output prevention film 12 includes (i) an adhesive layer 12a provided on and in direct contact with an exfoliative film 13, (ii) a light cutting layer 12b that blocks light having a wavelength of 420 nm or smaller, (iii) a PET base 12c, and (iv) a hard coat layer 12d, which are provided in this order.

The adhesive layer 12a is for attaching the excitation-light output prevention film 12 to the front end section 11a of the housing 11. In order to maintain adhesiveness of the adhesive layer 12 before the adhesive layer 12 is attached to the front end section 11a of the housing 11, an adhesive surface of the adhesive layer 12a is protected using the exfoliative film 13.

In order for the adhesive layer 12a to have adhesiveness, a conventional adhesive agent is applied to the adhesive surface of the adhesive layer 12a that adheres to the front end section 11a of the housing 11.

The light cutting layer 12b is prepared by dispersing, in a thermoplastic polyester (polyethylene terephthalate) resin having a thickness of 100 μm, a light absorbing agent for absorbing light having a wavelength of 420 nm or less. The light absorbing agent for absorbing light having a wavelength of 420 nm or less may be of an organic molecule having a benzene ring, such as a benzophenone- or benzoate-based molecule, a benzotriazole-based molecule, a triazine-based molecule, and the like. Light with a desired wavelength or less can be cut depending on densities of such organic molecules or combinations of the organic molecules.

The PET base 12c is a polymer film made from a thermoplastic polyester resin and having a thickness of 50 μm. The hard coat layer 12d is made from an optically or thermally reactive curable resin composition and has a thickness of 10 μm.

The excitation-light output prevention film 12 is attached to an inward side of the front end section 11a of the housing 11 by removing the exfoliative film 13, for example. Obviously, the excitation-light output prevention film 12 may be alternatively attached to an outward side of the front end section 11a of the housing 11. In this case, however, it is preferred that the adhesive layer 12a also contains an ultraviolet absorber dispersed therein so that no light having an intense wavelength of 450 nm or smaller directly enters the PET base 12c.

For another example, the excitation-light output prevention film 12 may be an optical film that scatters a light component having a wavelength of at least 400 nm or greater but not greater than 420 nm. Examples of the optical film encompass a so-called “frosted glass” having asperities formed on a surface and a film having fine particles of different refractive indices dispersed inside the film.

As described above, the excitation-light output prevention film 12 is an absorption film (absorption member) for absorbing coherent light maintaining coherence or a scattering film (scattering member) for scattering the coherent light maintaining coherence. Use of such films as the excitation-light output film 12 realizes the excitation-light output prevention function. Obviously, the excitation-light output prevention film 12 may be any one of the absorption film and the scattering film or a combination thereof.

The laser diode 3 of the headlamp 1 in accordance with the present embodiment may be a laser diode that emits a laser beam having a wavelength of 400 nm or greater but not greater than 420 nm, as described above.

A laser beam having a wavelength of less than 400 nm has a low visibility. As such, in a case where the laser diode 3 is a laser diode that emits a laser beam having a wavelength of less than 400 nm, especially less than 380 nm, for example, there is a risk that even if the laser beam emitted from the laser diode is leaked outside the headlamp 1 in the above described way, a leakage of the laser beam is not recognized by anyone.

Further, a laser diode beam having a wavelength of less than 380 nm and thereby falling in an (near-)ultraviolet region is invisible to human eyes. Therefore, the risk is increased. In contrast, in a case where the laser diode 3 is a laser diode that emits a laser beam having a wavelength of 400 nm or greater, it can be easy to visually detect the laser beam emitted from the laser diode. Therefore, even if a leakage of the laser beam occurs, it is easy to deal with the leakage.

On the other hand, a risk caused by viewing light having no coherence is as low as a risk caused by viewing normal light (which is incoherent light as compared to coherent light), even if the light has the same wavelength as that of the laser beam. Therefore, even in a case of viewing a laser beam having a wavelength of 400 nm or greater but not greater than 420 nm, it is not necessarily dangerous to human eyes

In the present embodiment, the laser beam emitted from the laser diode 3, which is a coherent laser beam, is normally directed to the light emitting section 7 and absorbed by the fluorescent material contained in the light emitting section 7. Then, the laser beam thus absorbed is converted in wavelength by the fluorescent material and emitted therefrom as fluorescence having a longer wavelength than that of the laser beam. At that time, the coherence of the laser beam is lost, and the laser beam becomes incoherent fluorescence.

Further, a part of the coherent laser beam emitted from the laser diode 3 loses the coherence by being subjected to scattering by particles of the fluorescent material. In this way, the part of the coherent laser beam becomes an incoherent laser beam, even in a case of not being converted in wavelength by the fluorescent material.

Further, even if some of the coherent laser beam emitted from the laser diode 3 do not lose the coherence and maintains to be coherent, the laser beam maintaining the coherence is blocked and absorbed by the excitation-light output prevention film 12 before the laser beam is emitted outside the headlamp 1. This assures safety.

(Other Effects yielded by Excitation-Light Output Prevention Film 12)

As described earlier, the headlamp 1 is designed such that the bundle of beams formed by the reflection mirror 8 is outwardly emitted from the headlamp 1 via the front end section 11a of the housing 11. This indicates that outside light can enter the headlamp 1 from the outside of the headlamp 1 via the front end section 11a of the housing 11.

If such outside light enters the light emitting section 7 provided inside the housing 11, the outside light causes the light emitting section 7 to unnecessarily emit fluorescence. This advances deterioration of the light emitting section 7.

In order to deal with this problem, the headlamp 1 in accordance with the present embodiment has the excitation-light output prevention film 12 attached to the front end section 11a of the housing 11, thereby blocking entrance of the outside light.

For example, in a case where the laser diode 3 of the headlamp 1 in accordance with the present embodiment is a one which emits a laser beam with a wavelength of 400 nm or greater but not more than 420 nm, the optical film constituting the excitation-light output prevention film 12 is designed to have the light cutting layer 12b which blocks light with a wavelength of not more than 420 nm.

In this case, outside light with a wavelength of not more than 420 nm is blocked by the excitation-light output prevention film 12, and consequently light does not enter the headlamp 1 from the outside thereof through the front end section 11a of the housing 11.

Accordingly, the light emitting section 7 does not emit light upon irradiation with the outside light. This prevents the light emitting section 7 from unnecessarily emitting light. This prevents deterioration of the light emitting section 7.

[Effect Yielded by Headlamp 1]

In the headlamp 1 designed as above, in a case where the front area of the light emitting section 7 is 3 mm² and the opening area of the reflection mirror 8 is 2000 mm², emitting a laser beam of 10 W from the light output surface 22 of the light guide section 2 causes a light flux of approximately 900 lm to be emitted and causes the light emitting section 7 to exhibit luminance of 75 cd/mm².

(Another Disposition of Excitation-light Output Prevention Film 12)

As described earlier, the excitation-light output prevention film 12 may be an absorbing film or a scattering film, or a combination thereof.

With reference to FIG. 1, the following describes another disposition of the excitation-light output prevention film 12.

As shown in FIG. 1, in a case where the excitation-light output prevention film 12 is an absorbing film, the excitation-light output prevention film 12 is attached to the front end section 11a of the housing 11.

The excitation-light output prevention film 12 may be alternatively attached to the transparent plate 9 covering the opening of the reflection 8, for example.

Alternatively, the excitation-light output prevention film 12 may be attached adjacently to the light emitting surface 7b of the light emitting section 7 (surface of the light emitting section 7 which is closer to the output side of the headlamp 1). In this case, an absorbing-film attaching member should be provided adjacently to the light emitting surface 7b of the light emitting section 7, and the absorbing film should be attached to the absorbing-film attaching member.

The excitation-light output prevention film 12 may be alternatively attached to both the front end section 11a of the housing 11 and the transparent plate 9 or to both the front end section 11a of the housing 11 and the light emitting surface 7b of the light emitting section 7. That is, the excitation-light output prevention film 12 should be made up of two absorbing films, and one of the two absorbing films (first absorbing member) should be attached to the transparent plate 9 or the light emitting surface 7b of the light emitting section 7, and the other of the two absorbing films (second absorbing member) should be attached to the front end section 11a of the housing 11.

In either case, it can be said that the excitation-light output prevention film 12 is positioned, with respect to the light emitting section 7, to be closer to the output side of the headlamp 1.

On the other hand, in a case where the excitation-light output prevention film 12 is a scattering film, the excitation-light output prevention film 12 may be attached to the transparent plate 9 covering the opening of the reflection mirror 8, for example.

Alternatively, the excitation-light output prevention film 12 may be provided adjacently to the light emitting surface 7b of the light emitting section 7 or the laser beam irradiation surface 7a of the light emitting section 7. In this case, a scattering-film attaching member should be provided adjacently to the light emitting surface 7b or the laser beam irradiation surface 7a of the light emitting section 7, and the scattering film should be attached to the scattering-film attaching member.

In a case where the excitation-light output prevention film 12 is provided adjacently to the light emitting surface 7b, it can be said that the excitation-light output prevention film 12 is positioned, with respect to the light emitting section 7, to be closer to the output side of the headlamp 1. On the other hand, in a case where the excitation-light output prevention film 12 is provided adjacently to the laser beam irradiation surface 7a, it can be said that the excitation-light output prevention film 12 is positioned, with respect to the light emitting section 7, to be closer to a laser-diode-3-side of the headlamp 1.

The excitation-light output prevention film 12 may be alternatively attached to both the front end section 11a of the housing 11 and the transparent plate 9 or to both the front end section 11a of the housing 11 and the light emitting surface 7b of the light emitting section 7. Alternatively, the excitation-light output prevention film 12 may be attached to both the front end section 11a of the housing 11 and the laser beam irradiation surface 7a of the light emitting section 7.

In a case where the excitation-light output prevention film 12 is made up of the absorbing film and the scattering film, the scattering film and the absorbing film should be positioned so that the laser beam emitted from the laser diode 3 enters the scattering film and the absorbing film in this order. With this, even in a case where the scattering film fails to completely scatter excitation light having coherence, the absorbing film can absorb the excitation light.

### Embodiment 2

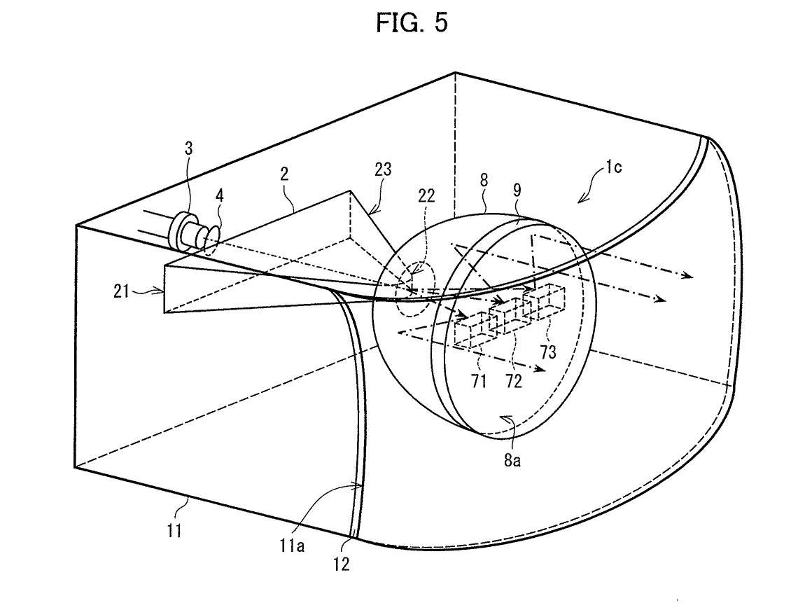

Embodiment 2 of the present invention is described below. FIG. 5 is a view schematically showing a configuration of a headlamp in accordance with Embodiment 2 of the present invention. Hereinafter, members similar to the members discussed in Embodiment 1 of the present invention are given same reference signs, and their explanations are omitted.

A headlamp 1c in accordance with the present embodiment is different from the headlamp 1 in accordance with Embodiment 1 in that a light emitting section 7 is replaced with three light emitting sections 71, 72, and 73.

In the headlamp 1 in accordance with Embodiment 1, there may be used the laser diode 3 which emits a laser beam with a wavelength of 400 nm or greater but not more than 420 nm. In this case, a laser beam with a wavelength of approximately 405 nm which is the wavelength of the excitation light is blocked by the excitation-light output prevention film 12.

Consequently, in a case where the fluorescent material contained in the light emitting section 7 is a simple mixture of a green fluorescent material (e.g. Caα-SiAlON: Ce) and a red fluorescent material (e.g. CASN: Eu, SCASN: Eu), a white light derived from fluorescent lights respectively from the fluorescent materials has a small controllable range of chromaticity since light with a wavelength of approximately 405 nm is blocked as above.

In order to deal with this problem, the headlamp 1c in accordance with the present embodiment is designed to include not only a light emitting section 71 containing a green fluorescent material (e.g. Caα-SiAlON: Ce mentioned above) and a light emitting section 72 containing a red fluorescent material (e.g. CASN: Eu, SCASN: Eu mentioned above) but also a light emitting section 73 containing a blue fluorescent material.

An example of the blue fluorescent material contained in the light emitting section 73 is an oxynitride fluorescent material containing JEM (JEM phase fluorescent material). The JEM phase fluorescent material is a material which is confirmed to be produced in a process of controlling a stable sialon fluorescent material by a rare earth element. The JEM phase is ceramics which was found as a grain boundary phase of a silicon nitride material, and is a crystalline phase (oxynitride crystal) having a unique atom sequence generally represented by composition formula M¹Al (Si_{6-z}Al_{z})N_{10-z}O_{z} wherein M¹ is at least one element selected from the group consisting of La, Ce, Pr, Nd, Sm, Eu, Gd, Tb, Dy, Ho, Er, Tm, Yb, and Lu, and z is a parameter. The JEM phase has a strong covalent bond between crystals and so is excellent in heat resistance. An example of the JEM fluorescent material is LaSiAlON: Ce. When the JEM fluorescent material contains a Ce component, it gets easier to realize emission ranging from blue to blue-green. When an excitation wavelength is 405 nm, the JEM phase: Ce fluorescent material has a peak wavelength of 490 nm and an emission efficiency of 50%.

In the headlamp 1c in accordance with the present embodiment, there are provided three light emitting sections: the light emitting sections 71, 72, and 73. Alternatively, there may be provided only one light emitting section in which the aforementioned three fluorescent materials (green fluorescent material, red fluorescent material, and blue fluorescent material) are mixed with one another and dispersed.

(Structure of Laser Diode 3)

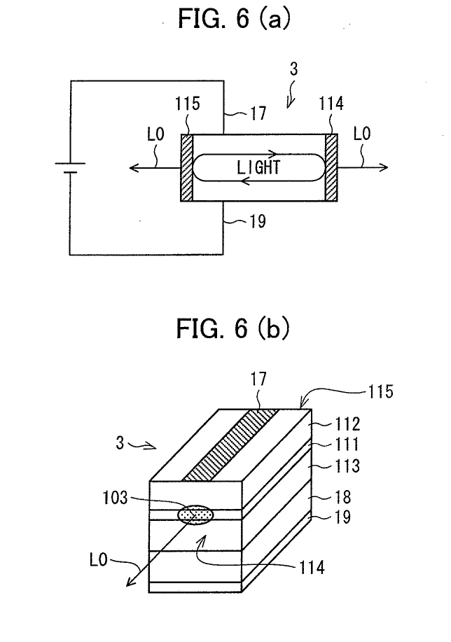

The following describes a basic structure of the laser diode 3 for use in the headlamp 1 in accordance with Embodiment 1 and the headlamp 1c in accordance with Embodiment 2. FIG. 6(a) is a circuit view showing the laser diode 3. FIG. 6(b) is a perspective view showing the basic structure of the laser diode 3. As shown in FIG. 6(b), the laser diode 3 includes a cathode electrode 19, a substrate 18, a clad layer 113, an active layer 111, a clad layer 112, and an anode electrode 17, which are stacked in this order.

The substrate 18 is a semiconductor substrate. The substrate 18 is generally made from a compound semiconductor such as GaAs or GaN. The substrate 18 may be alternatively made from (i) a IV group semiconductor such as Si, Ge, and SiC, (ii) a III-V group compound semiconductor such as GaAs, GaP, InP, AlAs, GaN, InN, InSb, GaSb, and AlN, (iii) a II-VI group compound semiconductor such as ZnTe, ZeSe, ZnS, and ZnO, (iv) an oxide insulator such as ZnO, Al₂O₃, SiO₂, TiO₂, CrO₂, and CeO₂, or (v) a nitride insulator such as SiN. It is preferable that the substrate 18 is made from the nitride semiconductor in particular.

The anode electrode 17 is provided for injecting an electric current into the active layer 111 via the clad layer 112.

The cathode electrode 19 is provided for injecting a current into the active layer 111 via the clad layer 113 from under the substrate 18. The current is injected by applying a forward bias to the anode electrode 17 and the cathode electrode 19.

The active layer 111 is sandwiched between the clad layer 113 and the clad layer 112.

A material of the active layer 111 may be (i) a III-V group compound semiconductor such as undoped GaAs, GaP, InP, AlAs, GaN, InN, InSb, GaSb, and AlN or (ii) a II-VI group compound semiconductor such as ZnTe, ZeSe, ZnS, and ZnO.

The active layer 111 is a region where light emission is caused by the injection of the current. Emitted light is trapped within the active layer 111 due to differences in refractive index between the active layer 111 and the clad layers 112 and 113.

Furthermore, the active layer 111 has a front cleaved surface 114 and a rear cleaved surface 115 which face each other so as to trap light amplified by stimulated emission. The front cleaved surface 114 and rear cleaved surface 115 serve as mirrors.

However, unlike mirrors which totally reflect light, light is amplified by induced emission in the active layer 111, and when the light is amplified to some extent, the light is outputted via one of the front cleaved surface 114 and the rear cleaved surface 115 (for convenience of explanation, it is assumed that the light is outputted via the front cleaved surface 114 in the present embodiment) and becomes a laser beam (excitation light) L0. The active layer 111 can have a multilayer quantum well structure.

The back cleavage surface 115, which faces the front cleavage surface 114, has a reflection film (not illustrated) for laser oscillation. By differentiating reflectance of the front cleavage surface 114 from reflectance of the back cleavage surface 115, it is possible for the excitation light L0 to be emitted from a luminous point 103 of an end surface having low reflectance (e.g., the front cleavage surface 114).

Each of the clad layer 113 and the clad layer 112 can be constituted by: n-type and p-type III-V group compound semiconductors such as that made of GaAs, GaP, InP, AlAs, GaN, InN, InSb, GaSb, or AlN; or n-type and p-type II-VI group compound semiconductors such as that made of ZnTe, ZeSe, ZnS, or ZnO. The electrical current can be injected into the active layer 111 by applying forward bias to the anode electrode 17 and the cathode electrode 19.

A semiconductor layer such as the clad layer 113, the clad layer 112, and the active layer 111 can be formed by a commonly known film formation method such as MOCVD (metal organic chemical vapor deposition), MBE (molecular beam epitaxy), CVD (chemical vapor deposition), laser-ablation, or sputtering. Each metal layer can be formed by a commonly known film formation method such as vacuum vapor deposition, plating, laser-ablation, or sputtering.

(Principle of Light Emission of Light emitting section 7)

Next, the following description discusses a principle of a fluorescent material emitting light upon irradiation with a laser beam emitted from the laser diode 3.

First, the fluorescent material contained in the light emitting section 7 is irradiated with the laser beam emitted from the laser diode 3. Upon irradiation with the laser beam, an energy state of electrons in the fluorescent material is excited from a low energy state into a high energy state (excitation state).

After that, since the excitation state is unstable, the energy state of the electrons in the fluorescent material returns to the low energy state (an energy state of a ground level, or an energy state of an intermediate metastable level between ground and excited levels) after a certain period of time.

As described above, the electrons excited to be in the high energy state returns to the low energy state. In this way, the fluorescent material emits light.

Note here that, white light can be made by mixing three colors which meet the isochromatic principle, or by mixing two colors which are complimentary colors for each other. The white light can be obtained by combining (i) a color of the laser beam emitted from the laser diode 3 and (ii) a color of the light emitted from the fluorescent material on the basis of the foregoing principle and relation.

### Embodiment 3

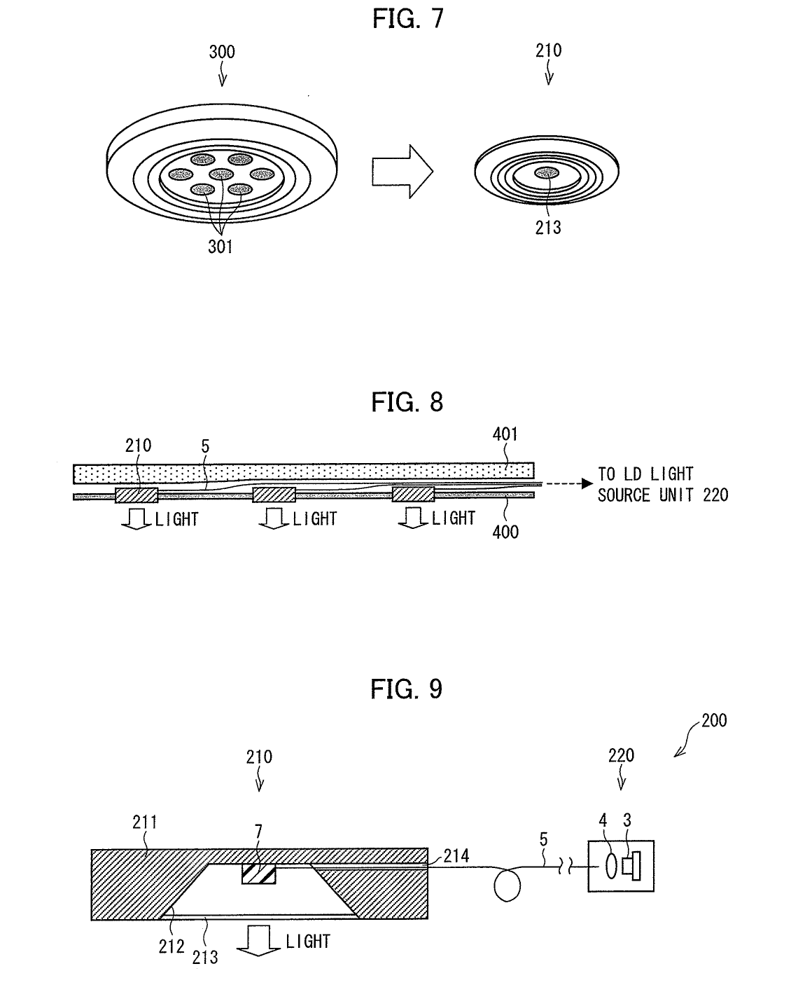

The following explains another embodiment of the present invention with reference to FIGS. 7-12. Members similar to those in Examples 1 and 2 are given the same reference numerals and explanations thereof are omitted here.

An explanation is made here as to a laser downlight 200 which is an example of an illuminating equipment of the present invention. The laser downlight 200 is an illuminating equipment to be installed into a ceiling of a structure such as a house and a vehicle. The laser downlight 200 uses, as illumination light, fluorescence generated when the light emitting section 7 is irradiated with a laser beam emitted from the laser diodes 3.

An illuminating equipment having a configuration similar to that of the laser downlight 200 may be installed into a side wall or a floor of a structure. Where the illuminating equipment is installed is not particularly limited.

FIG. 7 is a view schematically illustrating appearances of a light emitting unit 210 and a conventional LED downlight 300. FIG. 8 is a cross sectional view illustrating a ceiling where the laser downlight 200 is installed. FIG. 9 is a cross sectional view of the laser downlight 200. As illustrated in FIGS. 7-9, the laser downlight 200 includes the light emitting unit 210 which is embedded in a ceiling panel 400 and emits illumination light, and an LD light source unit 220 which supplies a laser beam to the light emitting unit 210 via an optical fiber 5. The LD light source unit 220 is not installed into the ceiling but is installed at a position where a user can easily touch the LD light source unit 220 (e.g. side wall of a house). The position of the LD light source unit 220 can be freely determined as above because the LD light source unit 220 and the light emitting unit 210 are connected with each other via the optical fiber 5. The optical fiber 5 is provided at a space between the ceiling 400 and a thermal insulator 401.

(Configuration of Light Emitting Unit 210)

As illustrated in FIG. 9, the light emitting unit 210 includes a housing 211, the optical fiber 5, the light emitting section 7, and a transparent plate 213.

The housing 211 has a recess 212. The light emitting section 7 is provided on a bottom surface of the recess 212. The recess 212 is coated with a metal thin film so as to serve as a reflection mirror.

Further, the housing 211 has a path 214 via which the optical fiber 5 extends to the light emitting section 7. A positional relationship between an output end part of the optical fiber 5 and the light emitting section 7 is similar to the one described above.

The transparent plate 213 is a transparent or semi-transparent plate positioned in such a manner as to seal an opening of the recess 212. The transparent plate 213 has the same function as the transparent plate 9. Fluorescence emitted from the light emitting section 7 passes through the transparent plate 213 and is emitted as illumination light. The transparent plate 213 may be removable from the housing 211 or may be omitted.

An optical film (not shown) having a function similar to that of the excitation-light output prevention film 12 is attached to the internal surface or the outer surface of the transparent plate 213.

In FIG. 7, the light emitting unit 210 has a circularly shaped outer periphery. However, the shape of the light emitting unit 210 (to be more exact, the shape of the housing 211) is not particularly limited.

It should be noted that a downlight is not required to have an ideal point light source unlike a headlamp, and is only required to have one luminous point. Therefore, the shape, the size, and the position of the light emitting section 7 are less limited than those of a headlamp.

(Configuration of LD Light Source Unit 220)

The LD light source unit 220 includes a laser diode 3, an aspheric lens 4, and an optical fiber 5.

An entrance end part, which is one end of the optical fiber 5, is connected with the LD light source unit 220. A laser beam emitted from the laser diode 3 enters the entrance end part of the optical fiber 5 via the aspheric lens 4.

FIG. 9 shows that only one pair of the laser diode 3 and the aspheric lens 4 is provided in an inside of the LD light source unit 220. In a case where a plurality of light emitting units 210 are provided, a bundle of optical fibers 5 respectively extended from the plurality of light emitting units 210 may be led to one LD light source unit 220. In this case, one LD light source unit 220 includes plural pairs of the laser diode 3 and the aspheric lens 4 and thereby serves as an integrated power source box.

(Modification Example of Installation of Laser Downlight 200)

FIG. 10 is a cross sectional view showing a modification example of installation of the laser downlight 200. As shown in FIG. 10, the laser downlight 200 may be installed in a modified manner described as follows. By taking advantages of characteristics such as thinness and light weight, a laser downlight main body (the light emitting unit 210) may be attached to a ceiling 400 having only a fine hole 402 for allowing the optical fiber 5 to run therethrough. This configuration is advantageous in that installation of the laser downlight 200 is less restricted and costs for the installation can be greatly reduced.

(Comparison of Laser Downlight 200 and Conventional LED Downlight 300)

As shown in FIG. 7, the conventional LED downlight 300 includes a plurality of transparent plates 301, and illumination light is emitted via the individual transparent plates 301. That is, the LED downlight 300 has a plurality of luminous points. The reason why the LED downlight 300 has the plurality of luminous points is that luminous flux of light emitted from the individual luminous points is relatively small and so a plurality of luminous points must be provided in order to assure light with luminous flux sufficient as illumination light.

In contrast thereto, the laser downlight 200 is an illuminating equipment that emits light of a high luminous flux. Therefore, the number of a luminous point for the laser downlight 200 may be one. This yields an effect that illumination light makes shades and shadows clear. Further, by using high color rendering fluorescent materials (e.g. a combination of plural kinds of oxynitride fluorescent material and/or nitride fluorescent material) as a fluorescent material of the light emitting section 7, it is possible to improve color rendering properties of illumination light.

This enables achieving high color rendering almost equal to that of an incandescent bulb. For example, light with high color rendering (general color rendering index Ra is 90 or more and special color rendering index R9 is 95 or more) which is difficult to be achieved by an LED downlight or a fluorescent lamp downlight can be achieved by combining a high color rendering fluorescent material with the laser diode 3.

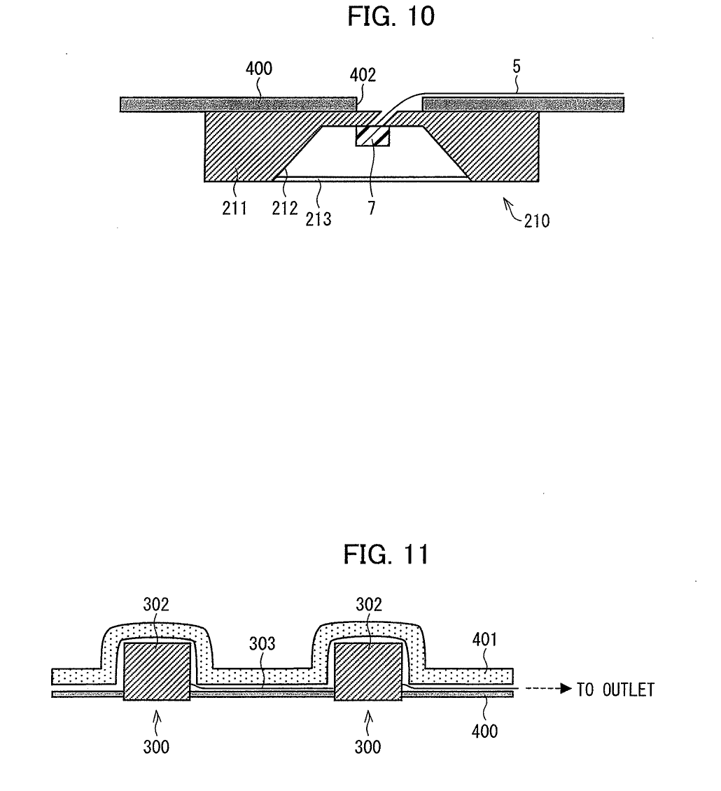

FIG. 11 is a cross sectional view of a ceiling to which LED downlights 300 are installed. As shown in FIG. 11, in each of the LED downlights 300, a housing 302 which houses an LED chip, a power source, and a cooling unit therein is embedded in the ceiling plate 400. The housing 302 is relatively large. A heat insulator 401 has a recess whose shape corresponds to the shape of the housing 302 and on which the housing 302 is positioned. A power source line 303 is extended from the housing 302 and connected with an outlet (which is not shown).

Such configuration gives a rise to the following problems. First of all, because a light source (LED chip) and a power source, which generate heat, are provided between the ceiling panel 400 and the heat insulator 401, use of the LED downlight 300 causes an increase in temperature of the ceiling, which reduces an efficiency of cooling the room.

Secondly, because the LED downlight 300 requires a power source and a cooling unit for each light source, total costs are increased.

Thirdly, because the housing 302 is relatively large, it is often difficult to provide the LED downlight 300 between the ceiling panel 400 and the heat insulator 401.

In contrast, in the laser downlight 200, the light emitting unit 210 does not include a large heat source. As such, use of the laser downlight 200 does not cause a reduction in the efficiency of cooling the room. This enables avoiding an increase in costs for cooling the room.

Further, in the laser downlight 200, it is unnecessary to provide a power source and a cooling unit for each light emitting unit 210. Thus, the laser downlight 200 can be small and thin. This reduces a restriction on a space where the laser downlight 200 is installed, and thereby makes it easier to install the laser downlight 200 into an existing house.

Further, because the laser downlight 200 is small and thin, the light emitting unit 210 can be provided on the surface of the ceiling 400, as described above. This enables reducing a restriction on installation of the laser downlight 200 and greatly reducing costs for the installation, as compared with installation of the LED downlight 300.

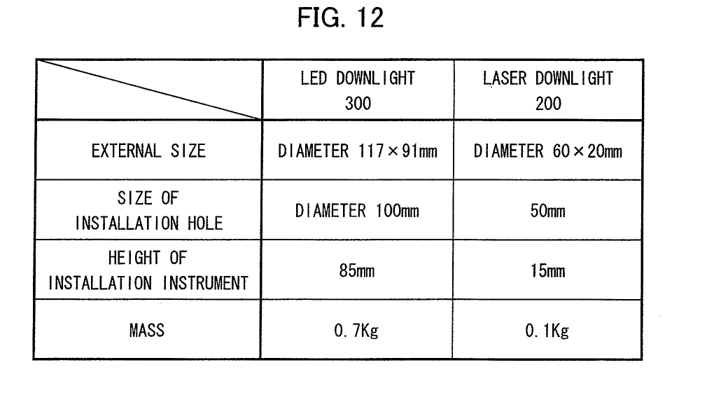

FIG. 12 is a table in which specifications of the laser downlight 200 and those of the LED downlight 300 are compared with each other. As shown in FIG. 12, in one example, a volume of the laser downlight 200 is smaller by 94% than that of the LED downlight 300 and a mass of the laser downlight 200 is smaller by 86% than that of the LED downlight 300.

Because the LD light source unit 220 can be installed at a place where a user can easily reach, it is possible to easily change the laser diode 3 when the laser diode 3 is in trouble. Further, by leading the optical fibers 5 respectively extended from the plurality of light emitting units 210 to one LD light source unit 220, it is possible to manage the plurality of laser diodes 3 at once. Therefore, even when two or more laser diodes 3 are to be replaced with new ones, it is possible to easily replace them.

In a case where the LED downlight 300 employs a high color rendering fluorescent material, the LED downlight 300 can emit a luminous flux of approximately 500 μm at a power consumption of 10 W. However, in order for the laser downlight 200 to emit a laser beam of same luminance, an optical output of 3.3 W is required. The optical output of 3.3 W corresponds to a power consumption of 10 W in a case where LD efficiency is 35%. Because the power consumption of the LED downlight is 10 W, there is no significant difference in power consumption between the laser downlight 200 and the LED downlight 300. Therefore, the laser downlight 200 enjoys various advantages as above, with the same power consumption as that of the LED downlight 300.

As described above, the laser downlight 200 includes (i) the LD light source unit 220 including at least one laser diode 3 for emitting a laser beam, (ii) at least one light emitting unit 210 including the light emitting section 7, the transparent plate 213 to which the optical film having the function similar to the excitation-light output prevention film 12 is attached, and the recess 212 serving as a reflection mirror, and (iii) the optical fiber 5 which directs the laser beam to the at least one light emitting unit 210.

The present invention is not limited to the description of the embodiments above, but may be altered by a skilled person within the scope of the claims. An embodiment based on a proper combination of technical means disclosed in different embodiments is encompassed in the technical scope of the present invention.

### OTHER DESCRIPTION OF THE PRESENT INVENTION

The present invention may be described as follows.

It is preferable to arrange the light emitting device of the present invention such that the excitation light output prevention member includes an absorbing member for absorbing the excitation light with coherence, and the absorbing member is positioned in a vicinity of the light emitting section in such a manner as to be closer to an output side of the light emitting device.

With the arrangement, the absorbing member can absorb excitation light (i) with which the light emitting section is not irradiated or (ii) with which the light emitting section is irradiated but which is neither absorbed nor scattered by the fluorescent material contained in the light emitting section and consequently is outputted from the light emitting section without any change while maintaining coherence.

Accordingly, it is possible to completely prevent the excitation light with coherence from being outputted outside the light emitting device.

It is preferable to arrange the light emitting device of the present invention so as to further include a mortar-shaped reflection mirror for reflecting the light emitted by the light emitting section so that the light is directed toward the output side of the light emitting device, the light emitting section being positioned inside the mortar-shaped reflection mirror, and the absorbing member being positioned inside the mortar-shaped reflection mirror in such a manner as to be in a vicinity of one surface of the light emitting section which one surface is closer to the output side of the light emitting device.

With the arrangement, since the absorbing member is in a vicinity of one surface of the light emitting section which one surface is closer to the output side of the light emitting device, excitation light which has not been used in emission of light and has passed through the absorbing member can be directed by the mortar-shaped reflection mirror to the output side of the light emitting device.

Therefore, it is possible to increase a utilization ratio of the excitation light, thereby increasing light outputted from the light emitting device.

It is preferable to arrange the light emitting device of the present invention so as to further include a mortar-shaped reflection mirror for reflecting the light emitted by the light emitting section so that the light is directed toward the output side of the light emitting device, the light emitting section being positioned inside the mortar-shaped reflection mirror, and the absorbing member being positioned outside the mortar-shaped reflection mirror.

With the arrangement, since the absorbing member is positioned outside the mortar-shaped reflection mirror, the absorbing member can be positioned, for example, on the light emitting surface of a housing for housing the reflection mirror.

It is preferable to arrange the light emitting device of the present invention so as to further include a housing for housing the reflection mirror, the housing having (i) a light emitting surface for emitting light coming from the reflection mirror toward the output side of the light emitting device, and (ii) a light blocking surface for blocking light coming from the reflection mirror toward a direction different from a direction toward the output side of the light emitting device, and the absorbing member being positioned on the light emitting surface of the housing.

With the arrangement, since the absorbing member is positioned outside the mortar-shaped reflection mirror, the absorbing member can be positioned on the light emitting surface of the housing for housing the reflection mirror.

It is preferable to arrange the light emitting device of the present invention so as to further include: a mortar-shaped reflection mirror for reflecting the light emitted by the light emitting section so that the light is directed toward the output side of the light emitting device; and a housing for housing the reflection mirror, the absorbing member including a first absorbing member and a second absorbing member, the light emitting section being positioned inside the mortar-shaped reflection mirror, the first absorbing member being positioned in a vicinity of the light emitting section in such a manner as to be closer to the output side of the light emitting device, the housing having (i) a light emitting surface for emitting light coming from the reflection mirror toward the output side of the light emitting device, and (ii) a light blocking surface for blocking light coming from the reflection mirror toward a direction different from a direction toward the output side of the light emitting device, and the second absorbing member being positioned on the light emitting surface of the housing.

With the arrangement, since the absorbing member is twofold, it is possible to secure safety sufficiently.

It is preferable to arrange the light emitting device of the present invention such that the first absorbing member is positioned inside the mortar-shaped reflection mirror in such a manner as to be in a vicinity of one surface of the light emitting section which one surface is closer to the output side of the light emitting device.

With the arrangement, since the absorbing member is in a vicinity of one surface of the light emitting section which one surface is closer to the output side of the light emitting device, excitation light having passed through the absorbing member without being used in emission of the light emitting section can be directed by the mortar-shaped reflection mirror to the output side of the light emitting device.

Therefore, it is possible to increase a utilization ratio of the excitation light, thereby increasing light outputted from the light emitting device.

It is preferable to arrange the light emitting device of the present invention such that the excitation light output prevention member includes a scattering member for scattering the excitation light with coherence.

With the arrangement, the scattering member can scatter (a) excitation light with which the light emitting section is not yet irradiated and which maintains coherence or (b) excitation light with which the light emitting section is not irradiated or excitation light with which the light emitting section is irradiated but which is neither absorbed nor scattered by the fluorescent material contained in the light emitting section so that the excitation light is outputted from the light emitting section without any change and consequently maintains coherence. Accordingly, it is possible to output the excitation light to the outside of the light emitting device after the excitation light has been converted to have incoherence.

Accordingly, it is possible to prevent the excitation light with coherence from being outputted outside the light emitting device.

It is preferable to arrange the light emitting device of the present invention so as to further include a mortar-shaped reflection mirror for reflecting the light emitted by the light emitting section so that the light is directed toward an output side of the light emitting device, the light emitting section being positioned inside the mortar-shaped reflection mirror, and the scattering member being positioned inside the mortar-shaped reflection mirror in such a manner as to be in a vicinity of one surface of the light emitting section which one surface is closer to the output side of the light emitting device.

With the arrangement, the scattering member is in a vicinity of one surface of the light emitting section which one surface is closer to the output side of the light emitting device. Accordingly, excitation light which has not been used in emission of the light emitting section and has been scattered by the scattering member to be converted to have incoherence can be directed by the mortar-shaped reflection mirror to the output side of the light emitting device.

Therefore, it is possible to increase a utilization ratio of the excitation light, thereby increasing light outputted from the light emitting device.

It is preferable to arrange the light emitting device of the present invention such that the scattering member is positioned in a vicinity of the light emitting section in such a manner as to be closer to the excitation light source, and the scattering member scatters excitation light coming from the excitation light source toward the light emitting section, and the light emitting section is irradiated with the excitation light scattered by the scattering member.

With the arrangement, it is possible to convert all the excitation light with coherence coming from the excitation light source into excitation light with incoherence before it reaches the light emitting section.

Consequently, the light emitting section is irradiated with only excitation light with incoherence. Accordingly, even if some excitation light is neither absorbed nor scattered by the fluorescent material contained in the light emitting section and is outputted from the light emitting section without any change, the excitation light does not have coherence.

Accordingly, it is possible to surely prevent excitation light with coherence from being outputted from the light emitting device without any change.

It is preferable to arrange the light emitting device of the present invention such that the excitation light output prevention member further includes an absorbing member for absorbing the excitation light with coherence, the excitation light from the excitation light source enters the scattering member and the absorbing member in this order, and the absorbing member absorbs excitation light coming from the excitation light source toward the output side of the light emitting device regardless of whether the light emitting section is irradiated with the excitation light.

With the arrangement, eve if the scattering member cannot completely scatter the excitation light with coherence, it is possible for the absorbing member to absorb the excitation light.

Accordingly, it is possible to prevent the excitation light with coherence from being outputted outside the light emitting device.

It is preferable to arrange the light emitting device of the present invention such that the light emitting section includes a green light emitting portion for emitting green light, a red light emitting portion for emitting red light, and a blue light emitting portion for emitting blue light.

When light emitted from the light emitting section passes through the absorbing member for absorbing excitation light, partial light with a wavelength to be absorbed by the absorbing member is also absorbed. This changes the color of the light emitted from the light emitting section.

In order to deal with this problem, the light emitting section with the above arrangement is designed so as to include a green light emitting portion for emitting green light, a red light emitting portion for emitting red light, and a blue light emitting portion for emitting blue light so that the green light emitted from the green light emitting portion, the red light emitted from the red light emitting portion, and the blue light emitted from the blue light emitting portion are mixed with one another.

In a case where light which is a mixture of lights from the three light emitting sections passes through the absorbing member for absorbing excitation light, even when the light is partially absorbed as described above, a change in the color of light due to absorption of the partial light can be subdued by controlling intensities of individual lights from the three light emitting sections beforehand.

It is preferable that an illuminating equipment in accordance with one embodiment of the present invention includes the aforementioned light emitting device.

With the arrangement, since the illuminating equipment includes the aforementioned light emitting device as a light source, the illuminating equipment can prevent excitation light with coherence from being outputted outside.

A vehicle headlamp in accordance with one embodiment of the present invention includes the aforementioned light emitting device.

With the arrangement, since the vehicle headlamp includes the aforementioned light emitting device as a light source, the vehicle headlamp can prevent excitation light with coherence from being outputted outside.

The present invention is not limited to the description of the embodiments above, but may be altered by a skilled person within the scope of the claims. That is, an embodiment based on a combination of technical means modified as needed within the scope of the claims is encompassed in the technical scope of the present invention.

### INDUSTRIAL APPLICABILITY

The present invention is a light emitting device that emits light of high luminance and high luminous flux but is smaller than a conventional light emitting device. The present invention can be applied to a vehicle headlamp, a projector, and the like.

### REFERENCE SIGNS LIST

1: headlamp (light emitting device)
2: light guide section
3: laser diode (excitation light source)
7: light emitting section
8: reflection mirror
11: housing
11a: front end section
12: excitation-light output prevention film (excitation-light output prevention member, absorption member, and scattering member)

1. A light emitting device, comprising:
an excitation light source for emitting excitation light with coherence; and
a light emitting section which, upon irradiation with the excitation light from the excitation light source, emits light so that the light is outputted from the light emitting device,
the light emitting device further comprising an excitation light output prevention member for preventing the excitation light from the excitation light source from being outputted from the light emitting device while the excitation light maintains coherence.

2. The light emitting device as set forth in claim 1, wherein
the excitation light output prevention member includes an absorbing member for absorbing the excitation light with coherence, and
the absorbing member is positioned in a vicinity of the light emitting section in such a manner as to be closer to an output side of the light emitting device.

3. The light emitting device as set forth in claim 2, further comprising a mortar-shaped reflection mirror for reflecting the light emitted by the light emitting section so that the light is directed toward the output side of the light emitting device,
the light emitting section being positioned inside the mortar-shaped reflection mirror, and
the absorbing member being positioned inside the mortar-shaped reflection mirror in such a manner as to be in a vicinity of one surface of the light emitting section which one surface is closer to the output side of the light emitting device.

4. The light emitting device as set forth in claim 2, further comprising a mortar-shaped reflection mirror for reflecting the light emitted by the light emitting section so that the light is directed toward the output side of the light emitting device,
the light emitting section being positioned inside the mortar-shaped reflection mirror, and
the absorbing member being positioned outside the mortar-shaped reflection mirror.

5. The light emitting device as set forth in claim 4, further comprising a housing for housing the reflection mirror,
the housing having (i) a light emitting surface for emitting light coming from the reflection mirror toward the output side of the light emitting device, and (ii) a light blocking surface for blocking light coming from the reflection mirror toward a direction different from a direction toward the output side of the light emitting device, and
the absorbing member being positioned on the light emitting surface of the housing.

6. The light emitting device as set forth in claim 2, further comprising:
a mortar-shaped reflection mirror for reflecting the light emitted by the light emitting section so that the light is directed toward the output side of the light emitting device; and
a housing for housing the reflection mirror,
the absorbing member including a first absorbing member and a second absorbing member,
the light emitting section being positioned inside the mortar-shaped reflection mirror,
the first absorbing member being positioned in a vicinity of the light emitting section in such a manner as to be closer to the output side of the light emitting device,
the housing having (i) a light emitting surface for emitting light coming from the reflection mirror toward the output side of the light emitting device, and (ii) a light blocking surface for blocking light coming from the reflection mirror toward a direction different from a direction toward the output side of the light emitting device, and
the second absorbing member being positioned on the light emitting surface of the housing.

7. The light emitting device as set forth in claim 6, wherein the first absorbing member is positioned inside the mortar-shaped reflection mirror in such a manner as to be in a vicinity of one surface of the light emitting section which one surface is closer to the output side of the light emitting device.

8. The light emitting device as set forth in claim 1, wherein the excitation light output prevention member includes a scattering member for scattering the excitation light with coherence.

9. The light emitting device as set forth in claim 8, further comprising a mortar-shaped reflection mirror for reflecting the light emitted by the light emitting section so that the light is directed toward an output side of the light emitting device,
the light emitting section being positioned inside the mortar-shaped reflection mirror, and
the scattering member being positioned inside the mortar-shaped reflection mirror in such a manner as to be in a vicinity of one surface of the light emitting section which one surface is closer to the output side of the light emitting device.

10. The light emitting device as set forth in claim 9, wherein
the scattering member is positioned in a vicinity of the light emitting section in such a manner as to be closer to the excitation light source, and the scattering member scatters excitation light coming from the excitation light source toward the light emitting section, and
the light emitting section is irradiated with the excitation light scattered by the scattering member.

11. The light emitting device as set forth in claim 8, wherein
the excitation light output prevention member further includes an absorbing member for absorbing the excitation light with coherence,
the excitation light from the excitation light source enters the scattering member and the absorbing member in this order, and
the absorbing member absorbs excitation light coming from the excitation light source toward the output side of the light emitting device regardless of whether the light emitting section is irradiated with the excitation light.

12. The light emitting device as set forth in claim 2, wherein
the light emitting section includes a green light emitting portion for emitting green light, a red light emitting portion for emitting red light, and a blue light emitting portion for emitting blue light.

13. An illuminating equipment comprising a light emitting device as set forth in claim 1.

14. A vehicle headlamp comprising a light emitting device as set forth in claim 1.
